(19) United States
(12) Patent Application Publication
(10) Pub. No.: US 2022/0253488 A1
(43) Pub. Date: Aug. 11, 2022

(54) METHODS AND APPARATUS TO PROCESS A MACHINE LEARNING MODEL IN A WEB-BROWSER ENVIRONMENT

(71) Applicant: Intel Corporation, Santa Clara, CA (US)

(72) Inventors: Jianhui Li, San Jose, CA (US); Yong Wu, Shanghai (CN); Ningxin Hu, Shanghai (CN); Yiqiang Li, Shanghai (CN); Yuanke Luo, Shanghai (CN)

(21) Appl. No.: 17/630,461

(22) PCT Filed: Sep. 27, 2019
(86) PCT No.: PCT/CN2019/108439

§ 371 Date: Jan. 26, 2022

(51) Int. Cl. G06F 16/954; G06N 3/04; G06N 3/08

(52) U.S. Cl. CPC G06F 16/954; G06N 3/08; G06N 3/0454

(57) ABSTRACT

Methods, apparatus, systems, and articles of manufacture to process a machine learning model in a web-browser environment are disclosed. An example apparatus includes a graph builder to accumulate machine learning operations as a graph. A tensor manager is to, in response to a request to access a tensor that is not yet available and associated with the machine learning operations, identify the graph based on the tensor. A graph cache manager is to determine whether a condensed graph corresponding to the identified graph is available. A graph condenser is to, in response to the graph cache manager determining that the condensed graph is not available, generate the condensed graph. A graph executor is to execute the condensed graph to create the tensor. The tensor manager is to provide the tensor as a response to the request to access the tensor.

### FIELD OF THE DISCLOSURE

This disclosure relates generally to machine learning, and, more particularly, to methods and apparatus to process a machine learning model in a web-browser environment.

### BACKGROUND

There is a trend in the computing industry to deploy machine learning (ML) workloads, especially deep learning (DL) models, to end-user edge devices, instead of server devices. Machine learning workloads have more recently been provided to end-user edge devices in web browser environment(s). Sometimes, DL computation is accomplished at the edge device by offloading computations from a central processing unit (CPU) to a graphics processing unit (GPU) or other circuitry.

### BRIEF DESCRIPTION OF THE DRAWINGS

FIG. 1 illustrates an example architecture to execute a machine learning task in a web browser environment.

FIG. 2 is a timeline of an example WebNN implementation executing operations to access tensor data.

FIG. 3 illustrates an example dynamic computation graph including a dynamic execution path

FIG. 4 illustrates an example delayed execution strategy.

FIG. 5 is a block diagram representing an example implementation of the WebNN controller of FIG. 1.

FIG. 6 is a flowchart representative of example machine readable instructions that may be executed to implement the example graph executor of FIG. 5.

FIG. 7 is a flowchart representative of example machine readable instructions that may be executed to implement the example tensor manager of FIG. 5.

FIG. 8 is a flowchart representative of example machine readable instructions that may be implemented to provide speculative execution of a condensed graph.

FIG. 9 is a flowchart representative of example machine readable instructions that may be implemented to execute a cached graph.

FIG. 10 is a block diagram representing input tensors hidden tensors, and an output tensor for a graph.

FIG. 11 is a table representing counter values for tracking a life cycle of tensors, operations, and a graph.

FIG. 12 is a block diagram representing input and output tensors for a condensed graph.

FIG. 13 is a block diagram of an example processor platform structured to execute the instructions of FIGS. 6, 7, 8, and/or 9 to implement the WebNN controller of FIGS. 1 and/or 5.

The figures are not to scale. In general, the same reference numbers will be used throughout the drawing(s) and accompanying written description to refer to the same or like parts.

Descriptors “first,” “second,” “third,” etc. are used herein when identifying multiple elements or components which may be referred to separately. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

### DETAILED DESCRIPTION

DL (Deep Learning) applications have been increasingly important and widely applied in image recognition, natural language processing, and strategy game applications. Thanks to its global reach, economies of scale, and cross-platform nature, the web platform has become the largest application development platform for many web developers. To address the increasing need of deploying DL application(s) in web browser(s), JavaScript (JS) based DL frameworks, such as TensorFlow.js and ONNX.js, have been emerging and the new Web standard, Web Neural Network API (WebNN), is being incubated in the W3C Machine Learning for the Web Community Group with support from all major browser vendors.

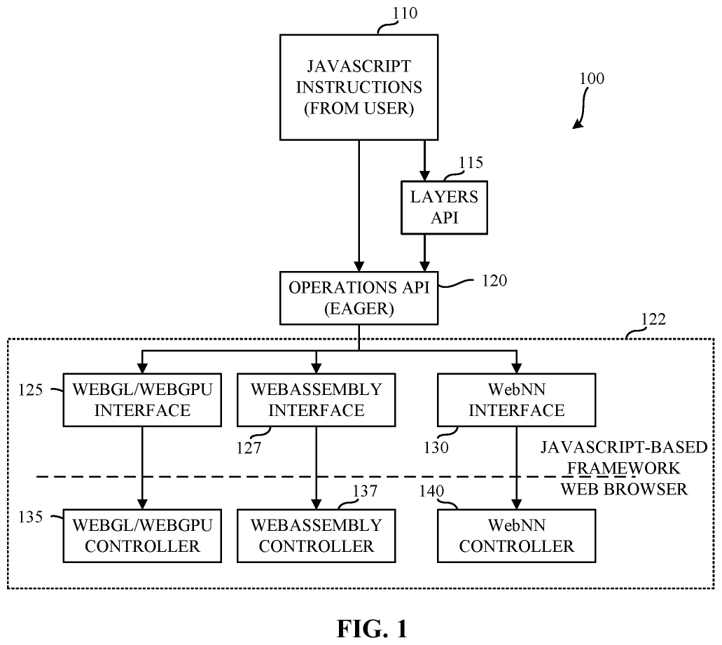

FIG. 1 is a diagram of an example architecture for execution of a machine learning task in a web browser environment. JavaScript-based deep learning frameworks (including, for example, TensorFlow.js), commonly utilize a layered design to provide both ease-of-use and flexibility. As shown in FIG. 1, a Layers application programming interface (API) 115 allows developers to write JavaScript instructions 110 representing static computation graph(s) of deep neural network (DNN) operations. The static computation graph(s) organize pre-defined operations. The lower-level operations API (Ops API) 120 provides a core data structure (e.g., a Tensor) and a set of DNN operations that represent computations (e.g., a convolution operation) to be performed on the data structure. The static computation graph built by the Layers API 115 utilizes the Ops API 120 to fulfill the computations by executing the operation of each layer. The Ops API 120 executes the operations in an eager mode. In the eager mode, the computation (e.g., execution) of a machine learning operation occurs immediately when an operation is called. Underneath, the Ops API 120 is structured to utilize one or more different controllers that support different web API implementations. The backend(s) 122 (e.g., one or more of the controllers and/or their respective interface(s)) executes the operations at the direction of the Ops API 120. In the illustrated example of FIG. 1, the Ops API 120 utilizes a WebGL/WebGPU interface 125, a WebAssembly interface 127, and a WebNN interface 130 to enable interaction with a respective WebGL/WebGPU controller 135, a WebAssembly controller 137, and a WebNN controller 140.

In some examples, different controllers are structured for different purposes and/or for execution on different hardware. The WebAssembly controller 137 supports C/C++ compiled byte-code that runs directly in a web browser. The example WebGL/WebGPU controller 135 provides shading language access to parallel execution units of a GPU. In this manner, the example WebAssembly controller 137 and the example WebGL/WebGPU controller 135 expose general purpose computing primitives for a specific hardware device (e.g., a mobile device, a desktop computer, a tablet computer, etc.). When WebAssembly or WebGL/WebGPU backends of the JavaScript-based framework are utilized, the web browser (e.g., the user application) does not have any knowledge of the machine learning operations.

The controllers 127 and 137 operate in an eager mode and, therefore, attempt to immediately respond to any request for execution of a machine learning operation, by executing and returning the result of the execution of the machine learning operation. As noted above, a graph may involve multiple different machine learning operations that form an ordered set of operations to be executed. An output (e.g., a tensor) from a first machine learning operation is typically provided as an input to a second machine learning operation. However, in previous architectures, the output from the first operation is passed back up to the Ops API by the controller 127, 137, so that the Ops API can determine the next operation to be performed, and that output (e.g., a tensor) is then passed back down to the controller 127, 137 for use as an input to a subsequent operation. Such passing of output (e.g., tensor) data back and forth in this manner includes significant communications overhead.

As disclosed herein, the WebNN controller 140 enables execution of machine learning operations in a delayed manner. When operated in a delayed manner, the WebNN controller 140 can become aware of the structure of inputs and/or outputs, and pass results (e.g., a tensor) of machine learning operations internally from one operation to the next, without needing to provide such results outside of the WebNN controller 140 until a final operation is completed and/or the final tensor is requested. In addition, an ability to provide such internal tensor data upon request, is also provided.

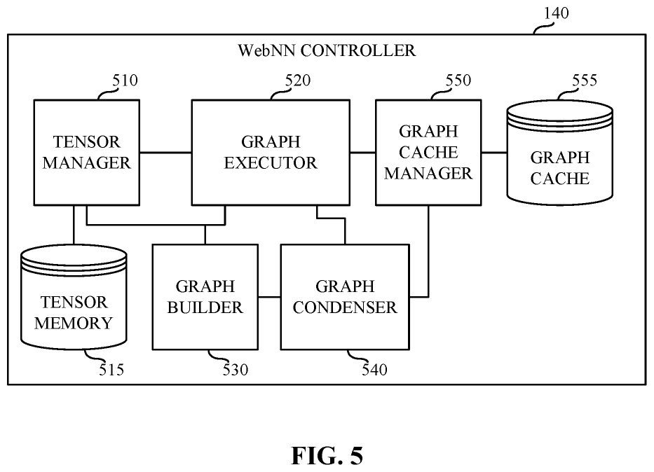

In examples disclosed herein, the example WebNN controller 140 exposes machine learning primitives, such as Tensor, Convolution, Pooling, Fully-Connected, Activations, etc. In this manner, the WebNN controller 140 can invoke a machine learning primitive when executing an operation. A naïve WebNN implementation in a web browser may thereby map the WebNN DNN primitive to a native DNN primitive and invoke native execution immediately. An example approach to implementing the WebNN controller 140 is disclosed in further detail in connection with FIG. 5, below.

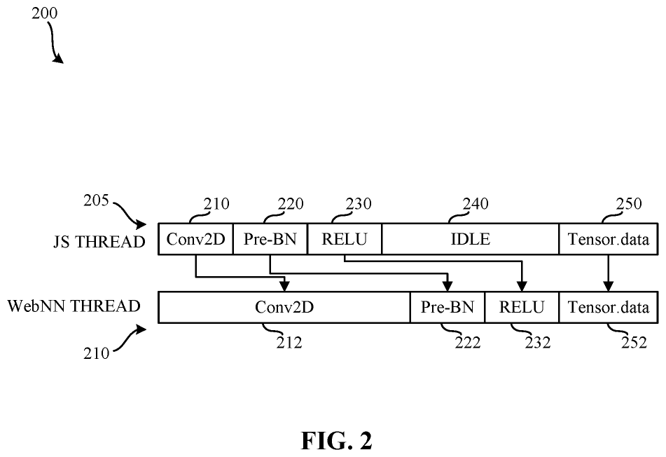

FIG. 2 is a timeline 200 of an example WebNN implementation executing operations to access tensor data computed by the WebNN controller 140 of FIG. 1. The example timeline 200 of FIG. 2 represents a JavaScript thread 205 and a WebNN thread 210. The example JavaScript thread 205 is implemented as a single thread. As a result, the JavaScript thread is shared with other tasks to be executed by a web browser, such as page layout and event handling. Consequently, long-running JavaScript functions can cause page slowdowns or delays for handling user events. To provide an enhanced user interface and/or user experience, the JavaScript-based DL framework disclosed herein performs asynchronous execution of operations, by handing some operations off to the WebNN thread 210. The example JavaScript thread 205 includes a two dimensional convolution (Conv2D) operation 210, a pre-bayesian network (Pre-BN) operation 220, a rectifier linear unit (RELU) operation 230, idle time 240, and a Tensor.data data retrieval operation 250. The example WebNN thread 210 includes a Conv2D operation 212, a Pre-BN operation 222, a RELU operation 232, and a Tensor.data data retrieval operation 252.

Operations such as Conv2D 212 are purposefully asynchronous and return a tensor whose data might not be computed yet. The operation is dispatched by the Ops API 120 to the WebNN thread 210 to be asynchronously executed by the WebNN Controller 140. In this manner, the example WebNN thread 210 may be executed by hardware separate from hardware executing the JavaScript thread 205 (e.g. another CPU core, a separate GPU, a separate accelerator, etc.). As a result, the JavaScript thread 205 is freed to handle other tasks. Later, when the user code (e.g., the JavaScript instructions 110) needs to retrieve the data that is backing a tensor (e.g., to retrieve Tensor.data 250), the JavaScript-based thread 205 requests the data from the WebNN thread 210 (e.g., from the WebNN controller 140). The JavaScript-based thread 205 and may wait for execution completion, and return the data to the user code (e.g., the webpage displayed in the browser).

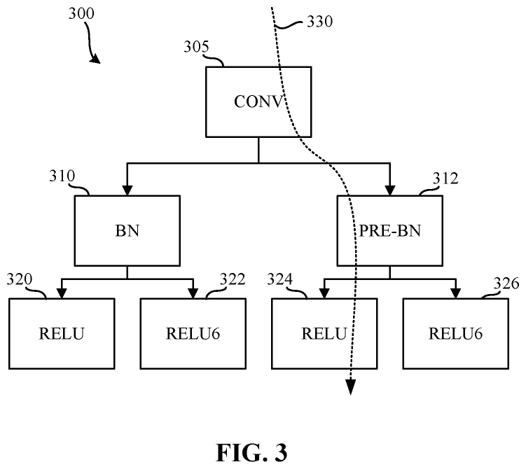

FIG. 3 illustrates an example dynamic computation graph 300 including a dynamic execution path. The example graph 300 of FIG. 3 includes a first node 305, a second node 310, a third node 312, a fourth node 320, a fifth node 322, a sixth node 324, and a seventh node 326. In examples disclosed herein, a node represents a machine learning operation to be performed. An example execution path 330 shows a path of execution including the first node 305, the third node 312, and the sixth node 324. In existing direct execution approaches, each node is executed in sequence and the next node in the path is selected after completion of the operation of the prior node. However, such approaches miss an opportunity to improve performance of the dynamic computation graph. For example, cross-iteration change(s) (e.g., the likelihood of a different path in the graph being chosen from one iteration to the next) for a dynamic computation graph may not be significant. Often, the selected path through the graph does not change over time. Thus, if at least a partial piece of the graph were condensed dynamically and the results of the condensing reused in future iterations without again executing the duplication function/instruction, performance of the execution of the graph may be improved.

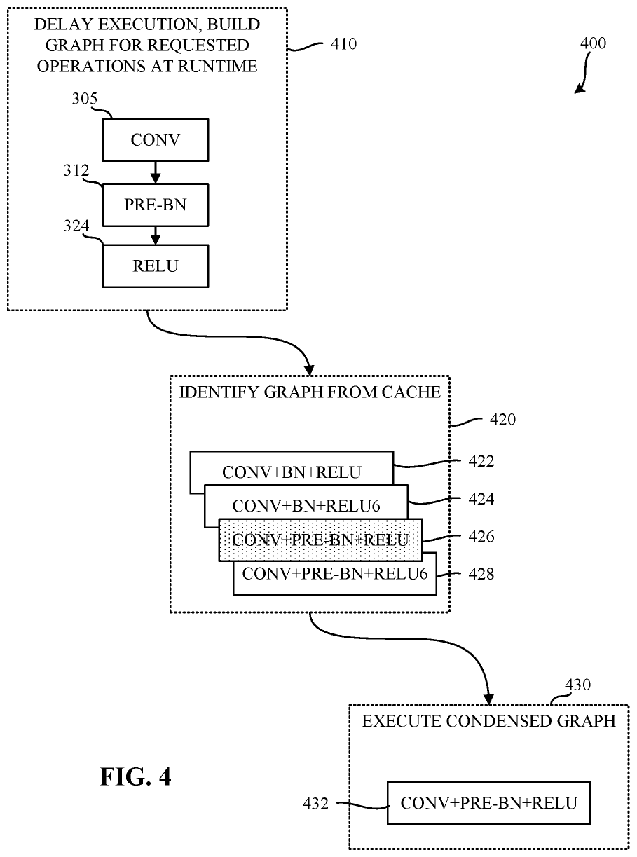

FIG. 4 illustrates an example delayed execution strategy 400. In a first phase 410, the nodes along the dynamic execution path 330 are identified (e.g., the first node 305, the third node 312, and the sixth node 324). In a second phase 420, possible combinations of nodes 422, 424, 426, 428 are identified. The combination of nodes representing the dynamic execution path 330 (e.g., combination 426) is selected for condensing (e.g., optimization). In a third phase 430, a condensed version 432 of the selected combination of nodes 426 is executed.

In this manner, delayed evaluation and dynamic optimization techniques are combined. The delayed evaluation enables condensing (e.g., optimization) opportunities, since delayed execution allows for the accumulation of machine learning operations and application of condensing (e.g., optimization) to them before the delayed execution is triggered. The dynamic optimization builds and condenses the graph dynamically and caches the condensed (e.g., optimized) graph for future use. Example approaches disclosed herein operate at the WebNN operation execution interface which receives the dispatched machine learning operations and condenses (e.g., optimizes) the execution.

FIG. 5 is a block diagram representing an example implementation of the WebNN controller 140 of FIG. 1. The example WebNN controller 140 of the illustrated example of FIG. 5 includes a tensor manager 510, a tensor memory 515, a graph executor 520, a graph builder 530, a graph condenser 540, a graph cache manager 550, and a graph cache 555.

The example tensor manager 510 implements an application programming interface (API) to enable access to a tensor, creation of tensors, and freeing of tensors by a user (and/or an application executed at the request of the user) to access tensor data. The example tensor manager 510 maintains the life cycle of tensors (e.g., manages storage of tensor data) and associates the tensor to delayed machine learning operations.

In some examples, the tensor manager 510 implements means for managing tensors. The example tensor manager 510 of the illustrated example of FIG. 5 is implemented by a logic circuit such as, for example, a hardware processor. However, any other type of circuitry may additionally or alternatively be used to implement the tensor manager 510 such as, for example, one or more analog or digital circuit(s), logic circuits, programmable processor(s), application specific integrated circuit(s) (ASIC(s)), programmable logic device(s) (PLD(s)), field programmable logic device(s) (FPLD(s)), digital signal processor(s) (DSP(s)), Coarse Grained Reduced precision architecture (CGRA(s)), image signal processor(s) (ISP(s)), etc.

The example tensor memory 515 of the illustrated example of FIG. 5 stores tensor data and/or objects at the direction of the tensor manager 510. As used herein, a tensor is a data object that includes data and a description of the data. The tensor description includes information such as a shape and/or other metadata describing the tensor data. The tensor is backed by a memory (e.g., the tensor memory 515). In examples disclosed herein, the tensor data is only accessible via the tensor manager 510. In some examples, a tensor object may be reused as the output tensor of a second operation, to enable reuse of the memory resource backing the tensor. In some such examples, the example tensor manager 510 frees the original tensor and creates a new one for the reused tensor.

The example tensor memory 515 of the illustrated example of FIG. 5 is implemented by any memory, storage device and/or storage disc for storing data such as, for example, flash memory, magnetic media, optical media, solid state memory, hard drive(s), thumb drive(s), etc. Furthermore, the data stored in the example tensor memory 515 may be in any data format such as, for example, binary data, comma delimited data, tab delimited data, structured query language (SQL) structures, etc. While, in the illustrated example, the tensor memory 515 is illustrated as a single device, the example tensor memory 515 and/or any other data storage devices described herein may be implemented by any number and/or type(s) of memories.

The example graph executor 520 accepts and executes one or more machine learning operations with tensor inputs and outputs. Such machine learning operations may be executed in a direct execution mode or in a delayed execution mode, based on information associated with the request to execute the machine learning operation. The example graph executor 520 determines whether the machine learning operation is to be executed in the direct execution mode or delayed execution mode. When running under direct execution mode, the example graph executor 520 executes the provided machine learning operation(s) directly. In some examples, the received request to execute the machine learning operation(s) may reference multiple machine learning operations. When running under delayed evaluation mode, instead of immediately executing the machine learning operation(s), the graph executor 520 sends the machine learning operation(s) to the example graph builder 530 to build a graph. The example graph builder 530 accumulates the machine learning operation(s) to form a sequence (represented by a graph).

The execution of the sequence may be triggered at a later time. The example graph executor 520 executes the operations of the graph (e.g., as requested via the WebNN interface 130) or a condensed (e.g., optimized) version of the graph (e.g., as built by the graph builder 530 and/or as modified by the graph condenser 540).

In some examples, the graph executor 520 implements means for executing a machine learning operation. The example graph executor 520 of the illustrated example of FIG. 5 is implemented by a logic circuit such as, for example, a hardware processor. However, any other type of circuitry may additionally or alternatively be used such as, for example, one or more analog or digital circuit(s), logic circuits, programmable processor(s), ASIC(s), PLD(s), FPLD(s), programmable controller(s), GPU(s), DSP(s), CGRA(s), ISP(s), etc.

The example graph builder 530 builds a graph representing the requested machine learning (ML) operations and maintains a life cycle of the graph(s). In examples disclosed herein, the graph is a directed acyclic graph (DAG). However, any other type of graph may additionally or alternatively be used. As used herein, a graph conceptually condenses multiple machine learning operation nodes into a single entity. The input tensor collection of the graphs machine learning operations are considered to be the input tensors of the graph. The output tensor, a collection of machine learning operations are considered as the output tensors the graph. The output tensors will be materialized when the graph, or corresponding condensed (e.g., optimized) graph, is to be executed. The example graph builder 530 decides how to build the graph from the operation sequence according to a build policy.

A simple example build policy implemented by the example graph builder 530 may look for fusion patterns in a sequence of a few operations and, if the operations inside the sequence do not match the fusion pattern, then the example graph builder 530 retires the first operation in the sequence and accepts a new operation to continue the condensing/optimization. The retired operation is dispatched immediately for execution. In some examples, a sophistic build policy is used to hold up to a threshold (e.g., a maximum) amount of operations until the need for immediate execution of some operations in the sequence. In some examples, user code requests access to internal data of a tensor, which has to be computed immediately to fulfill the request. In some other examples, the operation sequence grows to a size limit (e.g., an operation threshold). Between two iterations of topology execution, most likely the example graph executor 520 sees the same operation sequences, and the graph policy selects the same operation sub-sequences to build the graph.

In some examples, the graph builder 530 implements means for accumulating. The example graph builder 530 of the illustrated example of FIG. 5 is implemented by a logic circuit such as, for example, a hardware processor. However, any other type of circuitry may additionally or alternatively be used such as, for example, one or more analog or digital circuit(s), logic circuits, programmable processor(s), ASIC(s), PLD(s), FPLD(s), programmable controller(s), GPU(s), DSP(s), CGRA(s), ISP(s), etc.

The example graph condenser 540 performs optimizations like fusing some machine learning operations in a graph and creation of a modified (e.g., optimized) graph. In some examples, the graph condenser 540 compiles the machine learning operations to generate a binary (e.g., an optimized binary executable). The graph condenser 540 stores the condensed graph in the graph cache 555 via the example graph cache manager 550.

In some examples, the graph condenser 540 implements means for condensing. The example graph condenser 540 of the illustrated example of FIG. 5 is implemented by a logic circuit such as, for example, a hardware processor. However, any other type of circuitry may additionally or alternatively be used such as, for example, one or more analog or digital circuit(s), logic circuits, programmable processor(s), ASIC(s), PLD(s), FPLD(s), programmable controller(s), GPU(s), DSP(s), CGRA(s), ISP(s), etc.

The example graph cache manager 550 caches the condensed graph and manages the life cycle of condensed (e.g., optimized) graphs. The example graph cache manager 550 saves the graph condensing efforts for a graph being executed in a next iteration in the graph cache 555. In a typical training or inference process, the machine learning framework iterates the graph and executes every node for many iterations. As a result, the entirety of the graph frequently remains the same. Even as the graph is dynamically changed according to the input data, the change follows certain specific dynamic patterns which are repeatedly executed in many iterations. Different dynamic execution patterns may cause different condensed graphs. Once a condensed (e.g., optimized) graph is created, the condensed graph is cached (e.g., in the graph cache 555) and is reused until the end of the workload. When a size of the graph cache 555 reaches a limit, the graph cache manager 550 cache may perform garbage collection to remove one or more graphs (e.g., those graphs that are used least frequently). In some examples, the size of the graph cache 555 is measured in the number of graphs (e.g., un-condensed and/or condensed graphs) stored therein. However, any other approach for representing a size of the graph cache 555 may additionally or alternatively be used.

In some examples, when the overall reuse of the condensed graph is lower than a threshold ratio, the example graph cache manager 550 may inform the example graph executor 520 to fall back to direct execution mode.

In some examples, the graph cache manager 550 implements means for managing a graph cache. The example graph cache manager 550 of the illustrated example of FIG. 5 is implemented by a logic circuit such as, for example, a hardware processor. However, any other type of circuitry may additionally or alternatively be used such as, for example, one or more analog or digital circuit(s), logic circuits, programmable processor(s), ASIC(s), PLD(s), FPLD(s), programmable controller(s), GPU(s), DSP(s), CGRA(s), ISP(s), etc.

As noted above, the example graph cache 555 stores graphs (e.g., un-condensed graphs and/or condensed graphs) for execution by the graph executor 520. Thus, for each graph, there may be a corresponding condensed (e.g., optimized) graph cached in the graph cache 555. In examples disclosed herein, the graph cache 555 is organized as a hash table, and each graph itself is the key to retrieve the condensed (e.g., optimized) version of the graph. To speed up the retrieval, a hash code is computed from the metadata of machine learning operations and input/output tensors for each graph. The hash code is used as a shortcut key when saving the condensed graph to the graph cache 555, and the graph is also saved as a full key. As a result, the full key uniquely identifies the condensed graph. When the same graph is executed in a next iteration, its hash code is used to find the corresponding hash bucket. Then the graph is used to compare with the saved graph before retrieving the condensed graph. In this manner, the graph executor 520 may use the graph as a full key to retrieve and execute the condensed (e.g., optimized) graph after binding the input and output tensors.

The example graph cache 555 of the illustrated example of FIG. 5 is implemented by any memory, storage device and/or storage disc for storing data such as, for example, flash memory, magnetic media, optical media, solid state memory, hard drive(s), thumb drive(s), etc. Furthermore, the data stored in the example graph cache 555 may be in any data format such as, for example, binary data, comma delimited data, tab delimited data, structured query language (SQL) structures, etc. While, in the illustrated example, the graph cache 555 is illustrated as a single device, the example graph cache 555 and/or any other data storage devices described herein may be implemented by any number and/or type(s) of memories.

While an example manner of implementing the example WebNN controller 140 of FIG. 1 is illustrated in FIG. 5, one or more of the elements, processes and/or devices illustrated in FIG. 4 may be combined, divided, re-arranged, omitted, eliminated and/or implemented in any other way. Further, the example tensor manager 510, the example graph executor 520, the example graph builder 530, the example graph condenser 540, the example graph cache manager 550 and/or, more generally, the example WebNN controller 140 of FIG. 5 may be implemented by hardware, software, firmware and/or any combination of hardware, software and/or firmware. Thus, for example, any the example tensor manager 510, the example graph executor 520, the example graph builder 530, the example graph condenser 540, the example graph cache manager 550 and/or, more generally, the example WebNN controller 140 of FIG. 5 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example tensor manager 510, the example graph executor 520, the example graph builder 530, the example graph condenser 540, the example graph cache manager 550 and/or, more generally, the example WebNN controller 140 of FIG. 5 is/are hereby expressly defined to include a non-transitory computer readable storage device or storage disk such as a memory, a digital versatile disk (DVD), a compact disk (CD), a Blu-ray disk, etc. including the software and/or firmware. Further still, the example WebNN controller 140 of FIG. 1 may include one or more elements, processes and/or devices in addition to, or instead of, those illustrated in FIG. 5, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

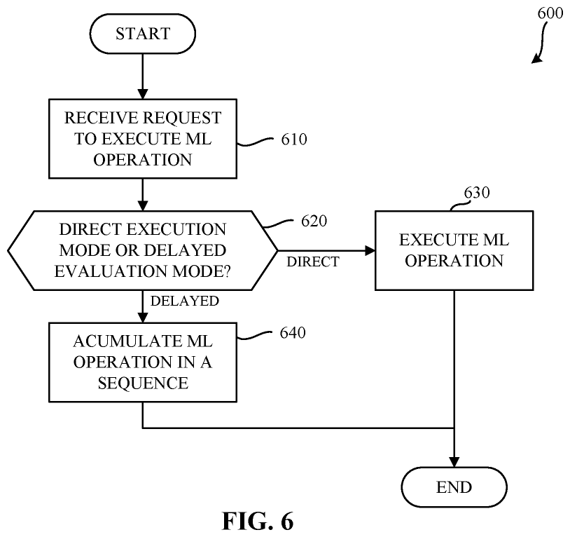

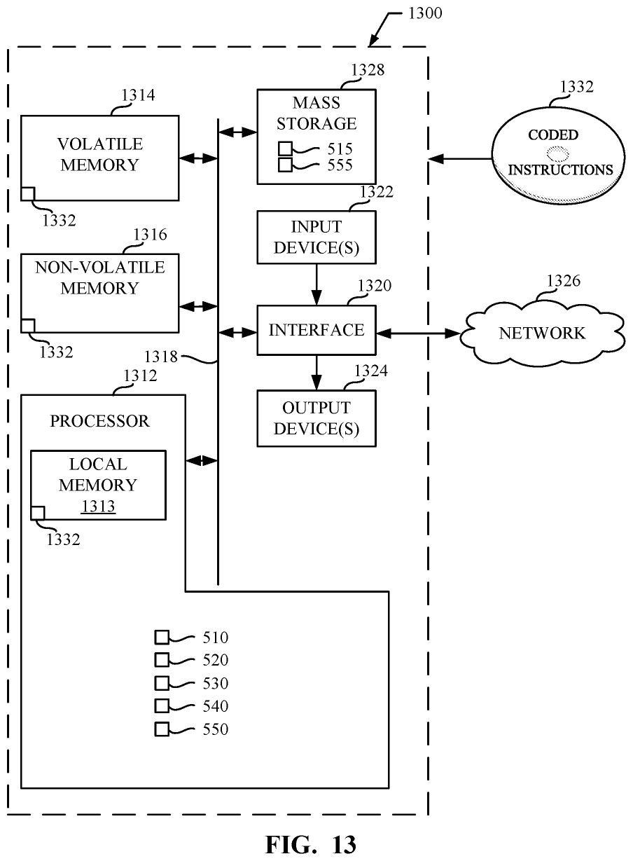

Flowcharts representative of example hardware logic, machine readable instructions, hardware implemented state machines, and/or any combination thereof for implementing the example WebNN controller 140 of FIG. 5 are shown in FIGS. 6, 7, 8, and/or 9. The machine readable instructions may be one or more executable programs or portion(s) of an executable program for execution by a computer processor such as the processor 1312 shown in the example processor platform 1300 discussed below in connection with FIG. 13. The program may be embodied in software stored on a non-transitory computer readable storage medium such as a CD-ROM, a floppy disk, a hard drive, a DVD, a Blu-ray disk, or a memory associated with the processor 1312, but the entire program and/or parts thereof could alternatively be executed by a device other than the processor 1312 and/or embodied in firmware or dedicated hardware. Further, although the example program is described with reference to the flowchart(s) illustrated in FIGS. 6, 7, 8, and/or 9, many other methods of implementing the example WebNN controller 140 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

The machine readable instructions described herein may be stored in one or more of a compressed format, an encrypted format, a fragmented format, a compiled format, an executable format, a packaged format, etc. Machine readable instructions as described herein may be stored as data (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement a program such as that described herein.

In another example, the machine readable instructions may be stored in a state in which they may be read by a computer, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, the disclosed machine readable instructions and/or corresponding program(s) are intended to encompass such machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example processes of FIGS. 6, 7, 8, and/or 9 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

FIG. 6 is a flowchart representative of example machine readable instructions 600 that may be executed to implement the example graph executor 520 of FIG. 5. As noted above, the example graph executor 520 is a central component which offers an execution API and orchestrates delayed evaluation. The example process 500 of FIG. 5 begins when the graph executor 520 receives a request to execute a machine learning operation. (Block 610). The example graph executor 520 determines whether the machine learning operation is to be executed in direct execution mode or delayed execution mode. (Block 620). When running under direct execution mode (e.g., block 620 returns a result of DIRECT), the example graph executor 520 takes one machine learning operation at a time and executes it directly. (Block 630). In some examples, the received request to execute the machine learning operation may reference multiple machine learning operations. When running under delayed evaluation mode (e.g., block 620 returns a result of DELAYED), instead of executing the machine learning operation(s), the graph executor 520 sends the machine learning operation(s) to the example graph builder 530 to build a graph. The example graph builder 530 accumulates the machine learning operation(s) to form a sequence. (Block 640).

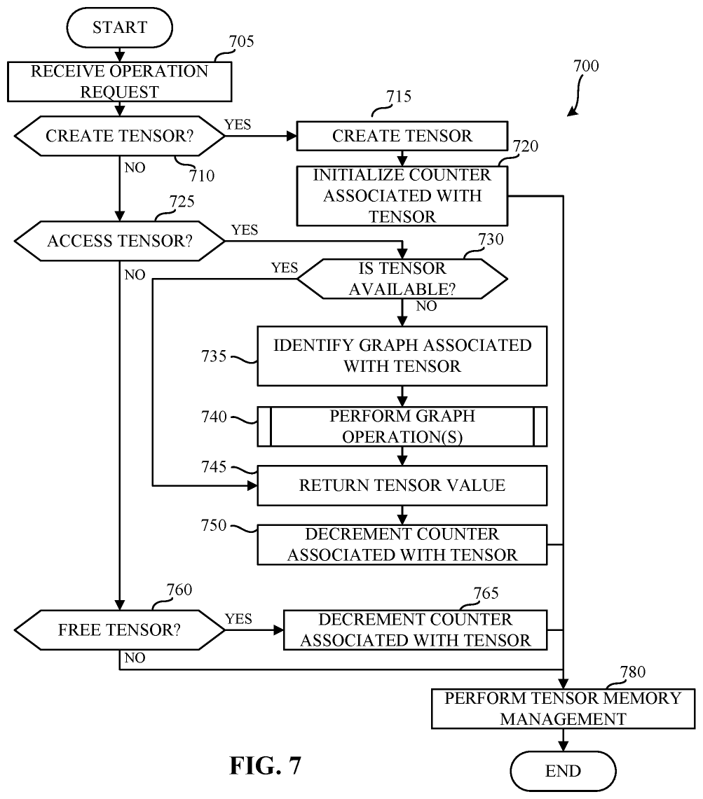

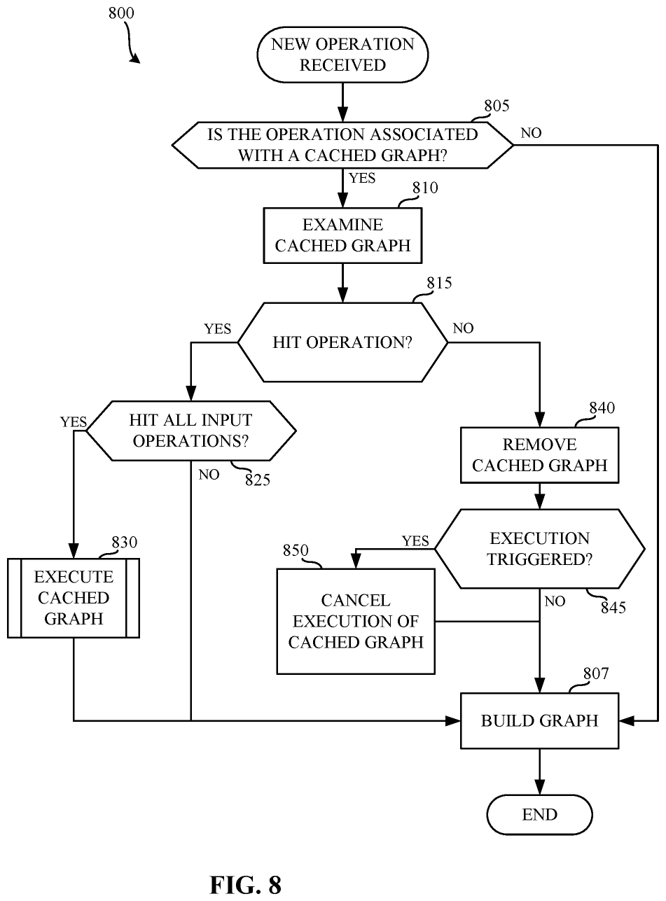

The example process 600 of FIG. 6 then terminates. As discussed below in connection with FIGS. 7, 8 and/or 9, when a user accesses tensor data via the example tensor manager 510 API, the delayed execution is triggered, causing building and/or condensing of the graph.

FIG. 7 is a flowchart representative of example machine readable instructions 700 that may be executed to implement the example tensor manager 510. As noted above, the example tensor manager 510 manages tensor life cycle. In examples disclosed herein, each tensor is associated with a reference counter, stored in association with the tensor in the tensor memory 515. When a tensor is created (e.g., memory is allocated for the tensor in the tensor memory 515), the reference counter associated with the tensor is initialized to one (see block 720). When a tensor is used as an input tensor of a machine learning operation (e.g., during execution of the graph, see block 740), the ML operation holds its reference and thus increases the reference counter associated with the tensor by one.

The example process 700 of the illustrated example of FIG. 7 begins when the tensor manager 510 receives a tensor operation request. (Block 705). In examples disclosed herein, the tensor operation request may request that a tensor be created (block 710), a tensor be accessed (block 725), or a tensor be freed (block 760).

When the requested operation is to create a tensor (e.g., block 710 returns a result of YES), the example tensor manager 510 creates the tensor in the tensor memory 515. (Block 715). The example tensor manager 510 initializes a counter associated with the tensor to a value of one. (Block 720). In some examples, the counter associated with the tensor may be initialized to a value other than one (e.g., to zero).

The example tensor manager 510 then performs tensor memory management operations. (Block 780). In examples disclosed herein, memory used by a tensor is cleared and made available for other tensors and/or data if the counter associated with the tensor is less than or equal to a threshold (e.g., zero). In some examples, a tensor object may be reused as the output tensor of a second operation. Such an approach enables the reuse of the memory resource backing the tensor. In such an example, the example tensor manager 510 frees the original tensor and creates a new one for the reused tensor.

When the requested operation is to access a tensor (e.g., block 725 returns a result of YES), the example tensor manager 730 determines whether the requested tensor is available. (Block 730). If the tensor is not available (e.g., block 730 returns a result of NO), the example tensor manager 510 identifies a graph associated with the tensor. (Block 735). The example tensor manager 740 passes the graph to the graph executor 740 for execution. (Block 740). An example approach to performing the graph operation(s) is described below in connection with FIG. 8. Upon execution of the graph to generate the requested tensor, the example tensor manager 510 then returns the tensor value. (Block 745).

Returning to block 730, in some examples, the tensor may have already been computed as a result of delayed execution (e.g., when block 730 returns a result of YES). If this is the case, the example tensor manager 510 returns the tensor value. (Block 745). The example tensor manager 510 then decrements the reference counter associated with the tensor. (Block 750). The example tensor manager 510 then performs tensor memory management. (Block 780). As noted above, in examples disclosed herein, memory used by a tensor is cleared and made available for other tensors and/or data if the counter associated with the tensor is less than or equal to a threshold (e.g., zero).

As described above in connection with FIG. 5, in some examples, a may be provided to the graph executor 520 to execute a machine learning model in a direct execution mode. In such an example, the ML operation is executed immediately by the graph executor 520 and frees the reference to input tensors (e.g., decrements the counter associated with the tensor). As a result, tensors are freed more quickly under the direct execution mode. In contrast, for a ML operation whose evaluation is delayed, referred to herein as delayed operation, the tensor manager 510 holds the reference to the input tensor much longer (e.g., until its output tensor is materialized), referred to herein as a matured operation.

When the requested operation is to create a tensor (e.g., block 760 returns a result of YES), the example tensor manager 510 decrements the counter associated with the tensor. (Block 765). Only when the tensor is freed and not referenced by any delayed operation, can it be safely deleted. An operation may become stale when its output tensor is deleted. When a tensor is freed, it may not be deleted when the example graph executor 520 is running under delayed evaluation mode. After decrementing the counter, the example tensor manager 510 then performs tensor memory management. (Block 780). As noted above, in examples disclosed herein, memory used by a tensor is cleared and made available for other tensors and/or data if the counter associated with the tensor is less than or equal to a threshold (e.g., zero). The example process 700 of FIG. 7 then terminates, but may be repeated upon receipt of a subsequent tensor operation request.

FIG. 8 is a flowchart representative of example machine readable instructions 800 that may be implemented to provide speculative execution of a condensed graph. In some examples, the example graph executor 520 executes a same condensed graph over multiple iterations. FIG. 8 represents an example implementation utilizing speculative execution of the condensed graph. Performing speculative execution enables the complete graph to be executed to, in the event that another tensor from the graph is later needed, be able to provide that tensor more quickly. The example tensor manager 510 determines whether the requested operation is associated with a cached graph. (Block 805). If the operation is not associated with a cached graph, using this speculative execution mode, the example graph builder 530 caches a graph built by prior execution iteration. When the example graph executor 520 sends a new operation to the example graph builder 530 (e.g., before building of the graph), the example graph builder 530 examines the operation against the cached graph to determine whether an operation hits (e.g., is included in) the cached graph. (Block 810).

If the example graph builder 530 determines that the cached graph is hit (e.g., block 815 returns a result of YES), the example graph builder determines whether all of the input operations were hit. (Block 825). If the example graph builder 530 finds that all of the input operations of the cached graph are hit (e.g., to be executed) (e.g., block 825 returns a result of YES), the example graph builder 530 triggers the example graph executor 520 to execute the condensed (e.g., optimized) graph with the cached graph as a full key. (Block 830). This triggers the execution of the condensed (e.g., optimized) graph ahead of one triggered by the example tensor manager 510 when accessing target tensor. The example graph executor 520 carries out the condensed graph asynchronously by leveraging another CPU core or off-CPU device, such as a GPU. Without waiting for completion of the condensed graph execution, the example graph executor 520 can keep accepting new operations and sending to the example graph builder 530. The example graph executor 520 then triggers building of the graph (block 807), enabling the graph to be re-constructed based on additionally received machine learning operations.

The example graph builder 530 decides how to build the graph (e.g., a directed acyclic graph, sometimes referred to as a DAG) from the operation sequence according to its build policy. An example build policy may look for fusion patterns in a sequence of a few operations. For example, if the operations inside the sequence doesn't match the fusion pattern, the example graph builder 530 may retry the first operation in the sequence and accept a new operation to continue the peephole optimization. The retried operation may then be dispatched immediately for execution. In some examples, a sophistic build policy could hold maximum amount of operations until the need to immediate execution of some operations in the sequence. In some examples, user code may request access to internal data of a tensor, which then has to be computed immediately. In some other examples, the operation sequence grows to a threshold size limit. Between two iterations of topology execution, most likely the example graph executor 520 sees the same operation sequences, and the graph policy selected the same operation sub-sequences to build the graph.

If the operation misses the cached graph (e.g., block 815 returns a result of NO), the example graph builder 530 removes the cached graph (Block 840). The example graph builder 530 determines whether execution of the cached graph has been triggered. (Block 845). If execution had been triggered (e.g., block 845 returns a result of YES), the example graph builder 530 notifies the example graph executor 520 to cancel the asynchronous execution of condensed (e.g., optimized) graph. (Block 850). Otherwise (e.g., if block 845 returns a result of NO), the example graph builder 530 keeps examining new operation sent by the example graph executor 520 until the example tensor manager 510 finally fetches the graph upon target tensor accessing. The example tensor manager 510 triggers the example graph executor 520 to execute graph. The example graph executor 520 checks the graph with asynchronous graph execution triggered by the example graph builder 530. If they are same, the example graph executor 520 waits for the completion of previous asynchronous graph execution.

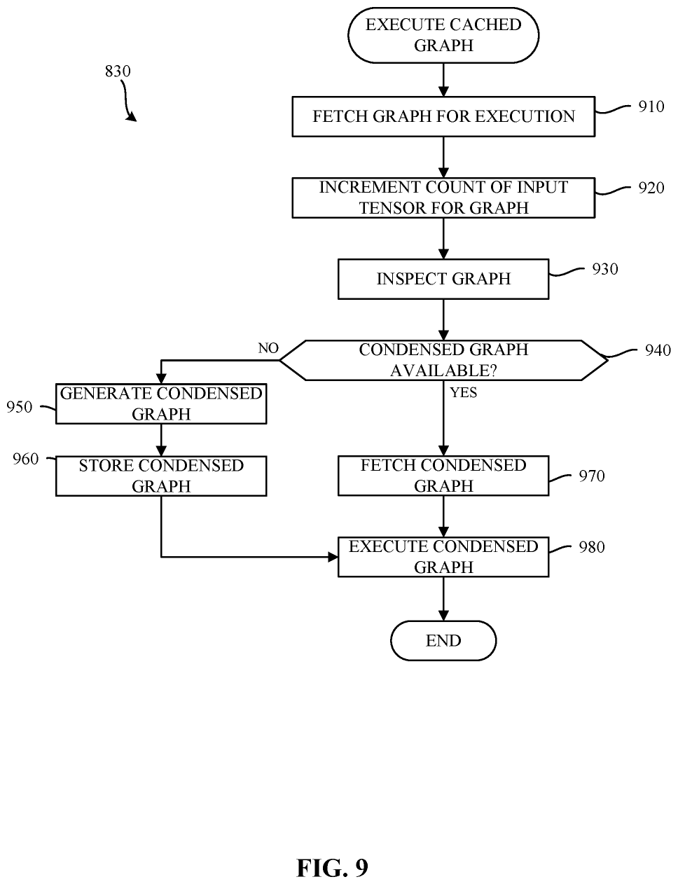

FIG. 9 is a flowchart representative of example machine readable instructions 900 that may be implemented to execute a cached graph. The example process 900 of FIG. 9 begins when the example graph executor cache manager 550 a graph for execution from the graph cache 555. (Block 910).

The example tensor manager 510 increments a counter for any input tensors of the graph. (Block 920). The example graph executor 520 inspects the graph to collect dynamic information (Block 930), and then attempts to determine whether a condensed version of the graph is available. (Block 940). In examples disclosed herein, the graph is used as a full key to attempt to determine whether a condensed version of the graph is available. If the retrieval is not successful (e.g., block 940 returns a result of NO), the example graph condenser 540 generates a condensed (e.g., optimized) graph. (Block 950). To generate the condensed graph, the example graph condenser 540 at least one of fuses several operations into one, reorders the operations, and/or transforms machine learning operation(s) to use more efficient computation. The example graph condenser 540, in some examples, compiles the machine learning operation(s) and generates a binary (e.g., an optimized binary). The example graph executor 520 decides when to shift the initial profiling stage to condensed execution stage. The example graph cache manager 550 stores the example condensed graph in the graph cache 555. (Block 960).

Returning to block 940, if the condensed graph is available (e.g., block 940 returns a result of YES), the example graph cache manager 550 fetches the condensed graph. (Block 970). The example graph executor 520 then executes the condensed graph, and materializes the output tensors with their returned value(s). (Block 980). The example process 900 of FIG. 9 then terminates, but may be repeated to execute a cached graph.

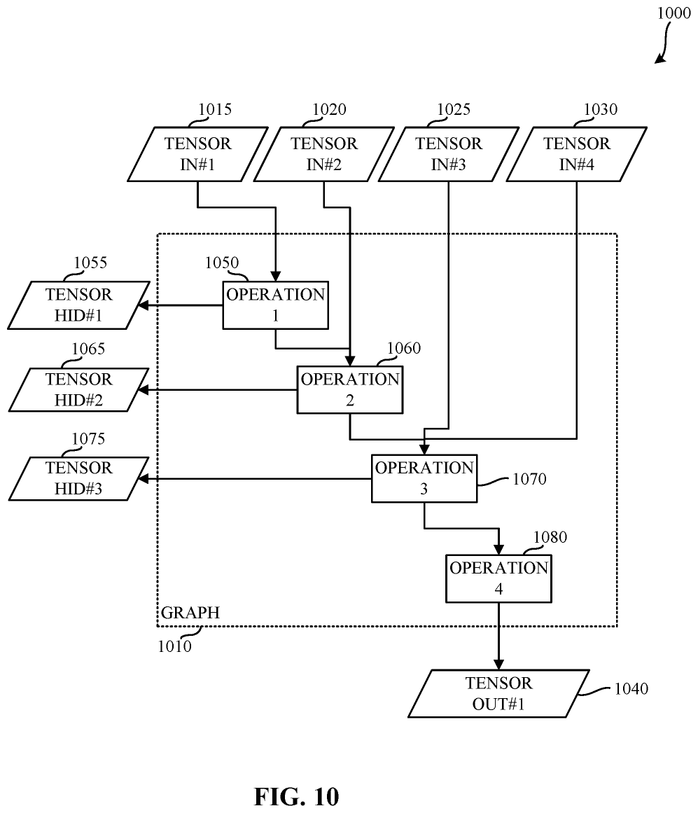

FIG. 10 is a block diagram 1000 representing input tensors hidden tensors, and an output tensor for a graph. In the illustrated example of FIG. 10, the graph 1010 includes a first operation 1050, a second operation 1060, a third operation 1070, and a fourth operation 1080. The operations 1050, 1060, 1070, 1080 represent various machine learning operations including, for example, a dropout operation, a convolution operation, a batch normalization operation, a Rectified Linear Unit activation function (ReLu), etc.

In some examples, a portion of the tensors resulting from an operation are to be provided to user code (e.g., materialized). In some other examples, such tensors need not be provided to user code. In some such examples, materialization of unnecessary tensors involves significant computation cost. Thus, for the output tensors which are not used outside of the graph (e.g., by user code), the graph could be condensed to produce and use the tensor data on the fly but never materialize them (e.g., never provide those tensors to user code). In examples disclosed herein, such intermediary tensors are referred to as hidden tensors. The example graph executor 520 tracks output tensors' usage and recognizes hidden tensors in its initial profiling run(s). If an output tensor is freed before any use after the graph being executed, then the tensor is marked as a hidden tensor. With this initial dynamic information, some tensors of the graph are removed.

In examples disclosed herein, the graph is transient since it represents a dynamic execution path of delayed machine learning operations. However, the graph cannot be freed immediately after a corresponding condensed graph is built, as the hidden tensors might be accessed any time later. Depending on the implementation, the hidden tensors might be freed immediately or at the end of each iteration, but they must be freed eventually to avoid a memory leak. When all its hidden tensors are freed, all operations become either mature or stale, and the graph does not hold any reference to input tensors. The graph and any hidden tensors are then safe to delete (and are deleted as part of the tensor management performed at block 780 of FIG. 7).

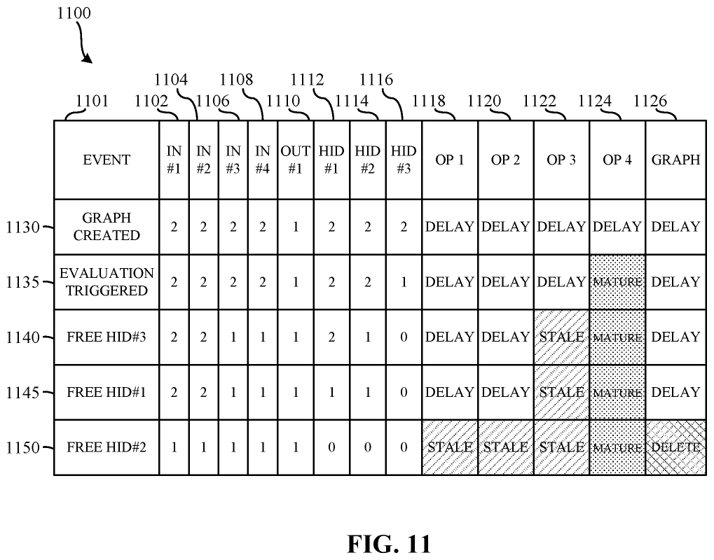

FIG. 11 is a table 1100 representing counter values for tracking a life cycle of tensors, operations, and a graph. The example table 1100 include an event column 1101 representing different events 1130, 1135, 1140, 1145, that may occur in connection with execution of a graph. The table 1100 includes columns referencing for input tensors 1102, 1104, 1106, 1108, an output tensor 1110, hidden tensors 1112, 1114, 1116, operations 1118, 1120, 1122, 1124, and the graph 1126.

The first input tensor column 1102 of FIG. 11 corresponds to a counter value for tensor IN #1 1015 of FIG. 10. The second input tensor column 1104 of FIG. 11 corresponds to a counter value for tensor IN #2 1020 of FIG. 10. The third input tensor column 1106 of FIG. 11 corresponds to a counter value for tensor IN #3 1025 of FIG. 10. The fourth input tensor column 1108 of FIG. 11 corresponds to a counter value for tensor IN #4 1030 of FIG. 10. The output tensor column 1110 of FIG. 11 corresponds to a counter value for the output tensor OUT #1 1040 of FIG. 10. The first hidden tensor column 1112 of FIG. 11 corresponds to a counter value for the hidden tensor HID #1 1055 of FIG. 10. The second hidden tensor column 1114 of FIG. 11 corresponds to a counter value for the hidden tensor HID #2 1065 of FIG. 10. The third hidden tensor column 1116 of FIG. 11 corresponds to a counter value for the hidden tensor HID #3 1075 of FIG. 10. The first operation column 1118 of FIG. 11 corresponds to a counter value for the first operation 1050 of FIG. 10. The second operation column 1120 of FIG. 11 corresponds to a counter value for the second operation 1060 of FIG. 10. The third operation column 1122 of FIG. 11 corresponds to a counter value for the third operation 1070 of FIG. 10. The fourth operation column 1124 of FIG. 11 corresponds to a counter value for the fourth operation 1080 of FIG. 10. The graph column 1126 of FIG. 11 corresponds to a counter value for the graph 1010 of FIG. 10.

In the illustrated example of FIG. 11, when the graph 1126 is first created (event 1130), all operations are delayed and hold the reference to input and hidden tensors. When evaluation is triggered (event 1135), operation 4 1124 becomes mature, which releases the reference to HID #3 1116. When HID #3 1116 is freed (event 1140), the reference count for HID #3 1116 is reduced to zero and thus can be deleted. Thus, the third operation 1122 becomes stale and releases the reference to HID #2 1114. When HID #1 1112 is freed (event 1145), HID #1 1112 is kept alive since the second operation 1120 still uses HID #1 1112, so its reference count is still 1. When HID #2 1114 is freed (event 1150), the deletion of HID #2 1114 makes operation 2 1120, which zeros out the reference to HID #1 1112. The deletion of HID #1 1112 makes the first operation 1118 stale, so eventually no operation in the graph 1126 is a delayed operation, and the graph 1126 is safe to delete.

In some examples, the hidden tensor is accessed only within the graph initially but being accessed outside the graph due to the dynamic nature of the graph. In such an example, the graph executor 520 analyzes the graph to identify all operations needed to materialize the hidden tensor and execute them. The hidden tensor is then included in the output tensor collection of the graph. The new graph is then re-condensed (e.g., re-optimized), to produce output tensors including the hidden tensor.

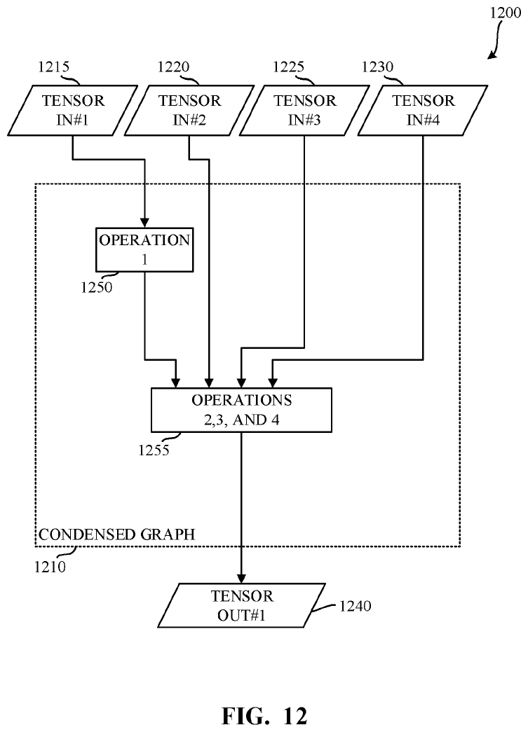

FIG. 12 is a block diagram 1200 representing input and output tensors for a condensed graph. In the illustrated example of FIG. 12, the condensed graph 1210 includes a first operation 1250, and a second operation 1255. In examples disclosed herein, the first operation 1250 corresponds to the first operation 1050 of FIG. 10. The second operation 1255 of FIG. 12 corresponds to a condensed version of the second operation 1060, the third operation 1070, and the fourth operation 1080 of FIG. 10. The example condensed graph 1210 receives a first input tensor 1215, a second input tensor 1220, a third input tensor 1225, and a fourth input tensor 1230. The second operation 1255 outputs an output tensor 1240. As noted above, the example graph condenser 540 compiles and/or condenses (e.g., optimizes) the graph (e.g., the graph 1010 of FIG. 10) to create the condensed graph (e.g., the condensed graph 1210 of FIG. 12). The example graph condenser 540 may fuse several computation(s) into one, reorder the computation, and/or transform machine learning operation(s) to use more efficient computation. It may also compile the machine learning operation(s) and generate a condensed (e.g., optimized) binary. In examples disclosed herein, the example graph executor 520 decides when to shift from the initial profiling stage to the condensed execution stage.

FIG. 13 is a block diagram of an example processor platform 1300 structured to execute the instructions of FIGS. 6, 7, 8, and/or 9 to implement the WebNN controller 140 of FIGS. 1 and/or 5. The processor platform 1300 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 1300 of the illustrated example includes a processor 1312. The processor 1312 of the illustrated example is hardware. For example, the processor 1312 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example tensor manager 510, the example graph executor 520, the example graph builder 530, the example graph condenser 540, and the example graph cache manager 550.

The processor 1312 of the illustrated example includes a local memory 1313 (e.g., a cache). The processor 1312 of the illustrated example is in communication with a main memory including a volatile memory 1314 and a non-volatile memory 1316 via a bus 1318. The volatile memory 1314 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 1316 may be implemented by flash memory and/or any other desired type of memory device. Access to the main memory 1314, 1316 is controlled by a memory controller.

The processor platform 1300 of the illustrated example also includes an interface circuit 1320. The interface circuit 1320 may be implemented by any type of interface standard, such as an Ethernet interface, a universal serial bus (USB), a Bluetooth® interface, a near field communication (NFC) interface, and/or a PCI express interface.

In the illustrated example, one or more input devices 1322 are connected to the interface circuit 1320. The input device(s) 1322 permit(s) a user to enter data and/or commands into the processor 1312. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1324 are also connected to the interface circuit 1320 of the illustrated example. The output devices 1324 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 1320 of the illustrated example, thus, typically includes a graphics driver card, a graphics driver chip and/or a graphics driver processor.

The interface circuit 1320 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 1326. The communication can be via, for example, an Ethernet connection, a digital subscriber line (DSL) connection, a telephone line connection, a coaxial cable system, a satellite system, a line-of-site wireless system, a cellular telephone system, etc.

The processor platform 1300 of the illustrated example also includes one or more mass storage devices 1328 for storing software and/or data. Examples of such mass storage devices 1328 include floppy disk drives, hard drive disks, compact disk drives, Blu-ray disk drives, redundant array of independent disks (RAID) systems, and digital versatile disk (DVD) drives.

The machine executable instructions 1332 of FIGS. 6, 7, 8, and/or 9 may be stored in the mass storage device 1328, in the volatile memory 1314, in the non-volatile memory 1316, and/or on a removable non-transitory computer readable storage medium such as a CD or DVD. In the illustrated example of FIG. 13, the mass storage device 1328 implements the example graph cache 555 and the example tensor memory 515.

From the foregoing, it will be appreciated that example methods, apparatus and articles of manufacture have been disclosed that improve the efficiency of using a computing device by enabling machine learning workloads to be executed in a browser in a condensed fashion.

Web-based activities of personal computer (PC) consumers form a large portion of PC usage scenarios. Example approaches disclosed herein enable execution of machine learning workloads in web-based environments in a more resource efficient manner. As disclosed herein, machine learning workloads can be executed more quickly, while still enabling full accessibility to internal tensors provided by the machine learning workload. Disclosed methods, apparatus and articles of manufacture are accordingly directed to one or more improvement(s) in the functioning of a computer.

Example are disclosed herein. Further example methods, apparatus, systems, and articles of manufacture to process a machine learning model in a web-browser environment include the following:

Example 1 includes an apparatus to process a machine learning model in a web browser, the apparatus comprising a graph builder to accumulate machine learning operations as a graph when the machine learning operations are to be executed using a delayed execution mode, a tensor manager to, in response to a request to access a tensor that is not yet available and associated with the machine learning operations, identify the graph based on the tensor, a graph cache manager to determine whether a condensed graph corresponding to the identified graph is available, a graph condenser to, in response to the graph cache manager determining that the condensed graph is not available, generate the condensed graph, and a graph executor to execute the condensed graph to create the tensor, the tensor manager to provide the tensor as a response to the request to access the tensor.

Example 2 includes the apparatus of example 1, wherein the graph executor is to, in response to the graph cache manager determining that the condensed graph is available, fetch the condensed graph.

Example 3 includes the apparatus of example 1, wherein the graph cache manager is to perform a lookup based on a hash of the identified graph to determine whether the condensed graph is available.

Example 4 includes the apparatus of example 1, wherein the graph executor is to, in response to determining that the machine learning operation is to be executed using a direct execution mode, execute the machine learning operation.

Example 5 includes the apparatus of example 1, wherein the tensor manager is to initialize a counter associated with the tensor, and in response to the providing of the tensor as the response, decrement the counter associated with the tensor.

Example 6 includes the apparatus of example 5, wherein the tensor manager is to, in response to a request to free the tensor, decrement the counter associated with the tensor.

Example 7 includes the apparatus of example 5, wherein the tensor manager is to, in response to execution of the condensed graph to create the tensor, increment the counter associated with the tensor.

Example 8 includes At least one non-transitory computer readable medium comprising instructions that, when executed, cause at least one processor to at least accumulate machine learning operations as a graph when the machine learning operations are to be executed using a delayed execution mode, identify, in response to a request to access a tensor that is not yet available and associated with the machine learning operations, the graph based on the tensor, determine whether a condensed graph corresponding to the identified graph is available, in response to determining that the condensed graph is not available, generating the condensed graph, executing the condensed graph to create the tensor, and providing the tensor as a response to the request to access the tensor.

Example 9 includes the at least one computer readable medium of example 8, wherein the instructions, when executed, cause the at least one processor to, in response to determining that the condensed graph is available, fetch the condensed graph.

Example 10 includes the at least one computer readable medium of example 8, wherein the instructions, when executed, cause the at least one processor to perform a lookup based on a hash of the identified graph to determine whether the condensed graph is available.

Example 11 includes the at least one computer readable medium of example 8, wherein the instructions, when executed, cause the at least one processor to, in response to determining that the machine learning operation is to be executed using a direct execution mode, execute the machine learning operation.

Example 12 includes the at least one computer readable medium of example 8, wherein the instructions, when executed, cause the at least one processor to initialize a counter associated with the tensor, and in response to the providing of the tensor as the response, decrement the counter associated with the tensor.

Example 13 includes the at least one computer readable medium of example 12, wherein the instructions, when executed, cause the at least one processor to, in response to a request to free the tensor, decrement the counter associated with the tensor.

Example 14 includes the at least one computer readable medium of example 12, wherein the instructions, when executed, cause the at least one processor to, in response to execution of the condensed graph to create the tensor, increment the counter associated with the tensor.

Example 15 includes an apparatus for processing a machine learning model in a web browser environment, the apparatus comprising means for accumulating machine learning operations as a graph when the machine learning operations are to be executed using a delayed execution mode, means for managing to identify, in response to a request to access a tensor that is not yet available and associated with the machine learning operations, the graph based on the tensor, means for determining whether a condensed graph corresponding to the identified graph is available, means for condensing to generate the condensed graph in response to the means for determining determining that the condensed graph is not available, and means for executing the condensed graph to create the tensor, wherein the means for managing is to provide the tensor as a response to the request to access the tensor.

Example 16 includes the apparatus of example 15, wherein the means for determining is to, in response to determining that the condensed graph is available, fetch the condensed graph.

Example 17 includes the apparatus of example 15, wherein the means for determining is to determine whether the condensed graph is available by performing a lookup based on a hash of the identified graph.

Example 18 includes the apparatus of example 15, wherein the means for executing is to, in response to the means for determining determining that the machine learning operation is to be executed using a direct execution mode, execute the machine learning operation.

Example 19 includes the apparatus of example 15, wherein the means for managing is further to initialize a counter associated with the tensor, and in response to the providing of the tensor as the response, decrement the counter associated with the tensor.

Example 20 includes the apparatus of example 19, wherein the means for managing is to, in response to a request to free the tensor, decrement the counter associated with the tensor.

Example 21 includes the apparatus of example 19, wherein the means for managing is to, in response to the means for executing executing the condensed graph to create the tensor, increment the counter associated with the tensor.

Example 22 includes a method of processing a machine learning model in a web browser environment, the method comprising accumulating machine learning operations as a graph when the machine learning operations are to be executed using a delayed execution mode, in response to a request to access a tensor that is not yet available and associated with the machine learning operations, identifying the graph based on the tensor, determining whether a condensed graph corresponding to the identified graph is available, in response to determining that the condensed graph is not available, generating the condensed graph, executing the condensed graph to create the tensor, and providing the tensor as a response to the request to access the tensor.

Example 23 includes the method of example 22, further including, in response to determining that the condensed graph is available, fetching the condensed version of the graph.

Example 24 includes the method of example 22, wherein the determining of whether the condensed identified graph is available includes performing a lookup based on a hash of the identified graph.

Example 25 includes the method of example 22, further including, in response to determining that the machine learning operation is to be executed using a direct execution mode, executing the machine learning operation.

Example 26 includes the method of example 22, further including initializing a counter associated with the tensor, and in response to the providing of the tensor as the response, decrementing the counter associated with the tensor.

Example 27 includes the method of example 26, further including, in response to a request to free the tensor, decrementing the counter associated with the tensor.

Example 28 includes the method of example 26, further including, in response to executing the condensed graph to create the tensor, incrementing the counter associated with the tensor.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

The following claims are hereby incorporated into this Detailed Description by this reference, with each claim standing on its own as a separate embodiment of the present disclosure.

1-28. (canceled)

29. An apparatus to process a machine learning model in a web browser, the apparatus comprising:
a graph builder to accumulate machine learning operations as a graph when the machine learning operations are to be executed using a delayed execution mode;
a tensor manager to, in response to a request to access a tensor that is not yet available and associated with the machine learning operations, identify the graph based on the tensor;
a graph cache manager to determine whether a condensed graph corresponding to the identified graph is available;
a graph condenser to, in response to the graph cache manager determining that the condensed graph is not available, generate the condensed graph; and
a graph executor to execute the condensed graph to create the tensor, the tensor manager to provide the tensor as a response to the request to access the tensor.

30. The apparatus of claim 29, wherein the graph executor is to, in response to the graph cache manager determining that the condensed graph is available, fetch the condensed graph.

31. The apparatus of claim 29, wherein the graph cache manager is to perform a lookup based on a hash of the identified graph to determine whether the condensed graph is available.

32. The apparatus of claim 29, wherein the graph executor is to, in response to determining that the machine learning operation is to be executed using a direct execution mode, execute the machine learning operation.

33. The apparatus of claim 29, wherein the tensor manager is to initialize a counter associated with the tensor, and in response to the providing of the tensor as the response, decrement the counter associated with the tensor.

34. The apparatus of claim 33, wherein the tensor manager is to, in response to a request to free the tensor, decrement the counter associated with the tensor.

35. The apparatus of claim 33, wherein the tensor manager is to, in response to execution of the condensed graph to create the tensor, increment the counter associated with the tensor.

36. At least one non-transitory computer readable medium comprising instructions that, when executed, cause at least one processor to at least:
accumulate machine learning operations as a graph when the machine learning operations are to be executed using a delayed execution mode;
identify, in response to a request to access a tensor that is not yet available and associated with the machine learning operations, the graph based on the tensor;
determine whether a condensed graph corresponding to the identified graph is available;
in response to determining that the condensed graph is not available, generating the condensed graph;
executing the condensed graph to create the tensor; and
providing the tensor as a response to the request to access the tensor.

37. The at least one computer readable medium of claim 36, wherein the instructions, when executed, cause the at least one processor to, in response to determining that the condensed graph is available, fetch the condensed graph.

38. The at least one computer readable medium of claim 36, wherein the instructions, when executed, cause the at least one processor to perform a lookup based on a hash of the identified graph to determine whether the condensed graph is available.

39. The at least one computer readable medium of claim 36, wherein the instructions, when executed, cause the at least one processor to, in response to determining that the machine learning operation is to be executed using a direct execution mode, execute the machine learning operation.

40. The at least one computer readable medium of claim 36, wherein the instructions, when executed, cause the at least one processor to:
initialize a counter associated with the tensor; and
in response to the providing of the tensor as the response, decrement the counter associated with the tensor.

41. The at least one computer readable medium of claim 40, wherein the instructions, when executed, cause the at least one processor to, in response to a request to free the tensor, decrement the counter associated with the tensor.

42. The at least one computer readable medium of claim 40, wherein the instructions, when executed, cause the at least one processor to, in response to execution of the condensed graph to create the tensor, increment the counter associated with the tensor.

43. An apparatus for processing a machine learning model in a web browser environment, the apparatus comprising:
means for accumulating machine learning operations as a graph when the machine learning operations are to be executed using a delayed execution mode;
means for managing to identify, in response to a request to access a tensor that is not yet available and associated with the machine learning operations, the graph based on the tensor;
means for determining whether a condensed graph corresponding to the identified graph is available;
means for condensing to generate the condensed graph in response to the means for determining determining that the condensed graph is not available; and
means for executing the condensed graph to create the tensor, wherein the means for managing is to provide the tensor as a response to the request to access the tensor.

44. The apparatus of claim 43, wherein the means for determining is to, in response to determining that the condensed graph is available, fetch the condensed graph.

45. The apparatus of claim 43, wherein the means for determining is to determine whether the condensed graph is available by performing a lookup based on a hash of the identified graph.

46. The apparatus of claim 43, wherein the means for executing is to, in response to the means for determining determining that the machine learning operation is to be executed using a direct execution mode, execute the machine learning operation.

47. The apparatus of claim 43, wherein the means for managing is further to initialize a counter associated with the tensor, and in response to the providing of the tensor as the response, decrement the counter associated with the tensor.

48. The apparatus of claim 47, wherein the means for managing is to, in response to a request to free the tensor, decrement the counter associated with the tensor.

49. The apparatus of claim 47, wherein the means for managing is to, in response to the means for executing executing the condensed graph to create the tensor, increment the counter associated with the tensor.

50. A method of processing a machine learning model in a web browser environment, the method comprising:
accumulating machine learning operations as a graph when the machine learning operations are to be executed using a delayed execution mode;
in response to a request to access a tensor that is not yet available and associated with the machine learning operations, identifying the graph based on the tensor;
determining whether a condensed graph corresponding to the identified graph is available;
in response to determining that the condensed graph is not available, generating the condensed graph;
executing the condensed graph to create the tensor; and
providing the tensor as a response to the request to access the tensor.

51. The method of claim 50, further including, in response to determining that the condensed graph is available, fetching the condensed version of the graph.

52. The method of claim 50, wherein the determining of whether the condensed identified graph is available includes performing a lookup based on a hash of the identified graph.

53. The method of claim 50, further including, in response to determining that the machine learning operation is to be executed using a direct execution mode, executing the machine learning operation.
